(19) United States
(12) Patent Application Publication
(10) Pub. No.: US 2026/0074088 A1
(43) Pub. Date: Mar. 12, 2026

(54) COMPRESSED STRANDED WIRE CONDUCTOR, CABLE USING THE SAME, AND CONNECTION STRUCTURE USING THE SAME

(71) Applicant: Proterial, Ltd., Tokyo (JP)

(72) Inventors: Detian HUANG, Tokyo (JP); Takanobu WATANABE, Tokyo (JP); Atsuro YAGUCHI, Tokyo (JP); Hiromitsu KURODA, Tokyo (JP)

(21) Appl. No.: 19/214,426

(22) Filed: May 21, 2025

(30) Foreign Application Priority Data
Sep. 12, 2024 (JP) 2024-157953

(51) Int. Cl. H01B 7/00; H01B 1/02; H01R 4/02

(52) U.S. Cl. CPC H01B 7/0009; H01B 1/026; H01R 4/023

(57) ABSTRACT

A compressed stranded wire conductor includes an outer diameter of 0.1 mm or less, a central portion, a plurality of surrounding portions spirally twisted around the central portion, a first metal part in which the central portion and the plurality of surrounding portions are fitted together to form a circular cross-section as a whole, and a second metal part made of a metal having higher conductivity than the first metal part and covering each of the central portion and the plurality of surrounding portions, wherein the central portion, the plurality of the surrounding portions, and adjacent ones of the surrounding portions, are attached together with the second metal part in between.

### CROSS-REFERENCE TO RELATED APPLICATIONS

The present application is based on Japanese patent application No. 2024-157953 filed on Sep. 12, 2024, the entire contents of which are incorporated herein by reference.

### TECHNICAL FIELD

The present invention relates to a compressed stranded wire conductor, a cable using the same, and a connection structure using the same.

### BACKGROUND OF THE INVENTION

In recent years, cables containing many wires, for example, more than 100 wires, have been used, and very thin conductors with an outer diameter of 0.1 mm or less, for example, have been used for the wires used in such cables.

Patent Literatures 1 and 2 below are prior art literature related to the invention of the present application.

### CITATION LIST

Patent Literature 1: JP2000-4604A
Patent Literature 2: JP2015-167092A

### SUMMARY OF THE INVENTION

When a single (solid) wire conductor, for example, is used as a conductor with a thin diameter as described above, it can be easily broken when subjected to bending, twisting, or other actions, although it has good electrical characteristics. Therefore, in order to increase resistance to bending or other actions, it is desirable to use a stranded conductor made by twisting multiple metal strands together as the thin conductor as described above. However, in this case, the electrical characteristics deteriorate due to small contact areas between the metal strands, and the outer diameter of the conductor needs to be larger in order to secure a desired conductor cross-sectional area.

To solve these problems, a compressed stranded wire conductor in which a stranded wire conductor is compressed, is considered to be used. By using the compressed stranded wire conductor, the contact areas between the metal strands can be increased to improve electrical characteristics, and at the same time, the outer diameter can be reduced. However, it is difficult to manufacture an extremely thin compressed stranded wire conductor with an outer diameter of 0.1 mm or less, because the metal strands are prone to breakage during compression. In addition, although electrical characteristics can be improved by using the compressed stranded wire conductor, they are still inferior to those of a single (solid) wire conductor. Therefore, it is desirable to improve the electrical characteristics furthermore.

For the above reason, the object of the present invention is to provide a compressed stranded wire conductor that is easy to manufacture and has improved electrical characteristics, a cable using the same, and a connection structure using the same.

### Measure to Solve the Problems

For the purpose of solving the above problem, the present invention provides a compressed stranded wire conductor, comprising:
an outer diameter of 0.1 mm or less;
a central portion;
a plurality of surrounding portions spirally twisted around the central portion;
a first metal part in which the central portion and the plurality of surrounding portions are fitted together to form a circular cross-section as a whole; and
a second metal part made of a metal having a higher conductivity than the first metal part and covering each of the central portion and the plurality of surrounding portions,
wherein the central portion, the plurality of surrounding portions, and adjacent ones of the surrounding portions are attached together with the second metal part in between.

With the aim of solving the above problem, the present invention also provides a cable having at least a compressed stranded wire conductor and a sheath covering around the compressed stranded wire conductor.

For the purpose of solving the above problem, the present invention also provides a connection structure to connect a conductor to an electrode formed on a substrate by solder,
wherein the conductor comprises:
an outer diameter of 0.1 mm or less;
a central portion;
a plurality of surrounding portions spirally twisted around the central portion;
a first metal part in which the central portion and the plurality of surrounding portions are fitted together to form a circular cross-section as a whole; and
a second metal part made of a metal having a higher conductivity than the first metal part and covering each of the central portion and the plurality of surrounding portions,
wherein the central portion, the plurality of surrounding portions, and adjacent ones of the surrounding portions are attached together with the second metal part in between, and
wherein the solder does not penetrate into the interior of the compressed stranded wire conductor.

### Advantageous Effects of the Invention

According to the present invention, it is possible to provide a compressed stranded wire conductor that is easy to manufacture and has improved electrical characteristics, a cable using the same, and a connection structure using the same.

### BRIEF DESCRIPTION OF THE DRAWINGS

FIG. 1A is a schematic cross-sectional view perpendicular to the longitudinal direction of a compressed stranded wire conductor according to an embodiment of the present invention.

FIG. 1B is a photograph showing a cross-sectional view perpendicular to the longitudinal direction of the compressed stranded wire conductor.

FIG. 2 is a cross-sectional view perpendicular to the longitudinal direction of a cable according to an embodiment of the present invention.

FIG. 3A is a cross-sectional view perpendicular to the longitudinal direction of a multi-core cable according to an embodiment of the present invention.

FIG. 3B is a cross-sectional view of the child stranded wires that constitute the multi-core cable.

FIG. 4A is a diagram illustrating a connection structure according to an embodiment of the present invention.

FIG. 4B is a photograph showing a cross-section at the connection portion between the compressed stranded wire conductor and an electrode.

FIG. 5 is a photograph showing a cross-section at the connection between a stranded conductor made by concentrically twisting seven metal strands and an electrode, for comparison with the present invention.

### DETAILED DESCRIPTION OF THE INVENTION

### Embodiment

Next, an embodiment of the present invention is described below according to the accompanying drawings.

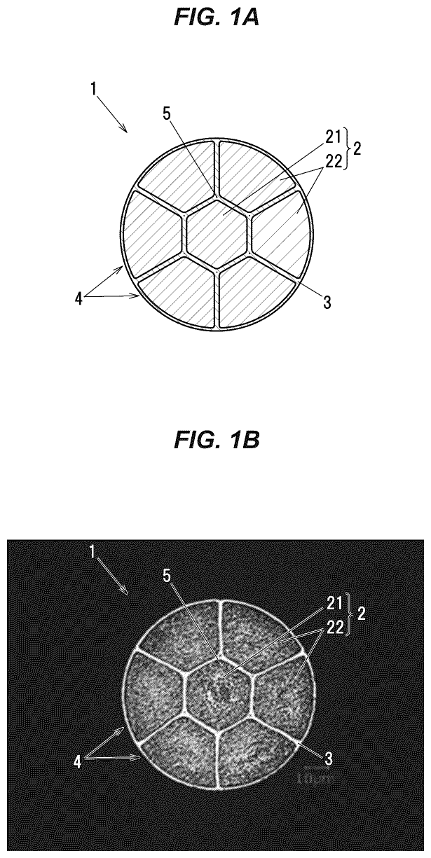

FIG. 1A is a schematic cross-sectional view perpendicular to the longitudinal direction of a compressed stranded wire conductor 1 according to an embodiment of the present invention. FIG. 1B is a photograph showing a cross-section perpendicular to the longitudinal direction of the compressed stranded wire conductor 1. The compressed stranded wire conductor 1 is very thin, with an outer diameter of 0.1 mm or less (38 AWG). In order to cope with the trend toward multi-core and smaller diameter cables, conductors with smaller diameters are in demand. Thus, it is more preferable that the outer diameter of the compressed stranded wire conductor 1 be 0.061 mm or less (43 AWG).

As shown in FIGS. 1A and 1B, the compressed stranded wire conductor 1 has a first metal part 2 and a second metal part 3 made of different metal materials from each other. The second metal part 3 is made of a metal with higher conductivity than the first metal part 2. In the present embodiment, the first metal part 2 is made of copper or a copper alloy, and the second metal part 3 is made of silver. Because of the high adhesiveness between the copper alloy and silver, delamination is less likely to occur during the compression process described below, and disconnection or other problems caused by delamination are also less likely to occur. In addition, since silver has a high electrical conductivity, its use as the second metal part 3 has the advantage of greatly improving the electrical characteristics (attenuation characteristics) of the compressed stranded wire conductor 1.

In the present embodiment, a copper alloy, which is copper containing silver, indium, and tin, is used as the first metal part 2. This makes it difficult to break the wire even when the diameter is reduced, and also makes it possible to maintain a sufficiently high electrical conductivity (e.g., about 85%). It is desirable to use pure copper with a purity of 99.99% or higher as a base of the copper alloy that constitutes the first metal part 2, because high impurities will cause the wire to break easily. When copper is used as the first metal part 2, it is also desirable to use pure copper such as oxygen-free copper with a purity of 99.99% or higher to prevent wire breakage even when the diameter is reduced.

In the present embodiment, a copper alloy is used for the first metal part 2 and silver is used for the second metal part 3. However, not limited to this, any metal material may be appropriately selected as long as the conductivity of the second metal part 3 is higher than that of the first metal part 2. For example, it is possible to use a copper alloy for the first metal part 2 and copper (pure copper) for the second metal part 3.

The first metal part 2 has a central portion 21 located at the center of the conductor and a plurality of surrounding portions 22 spirally twisted around the central portion 21. Here, six surrounding portions 22 are arranged around one central portion 21. The central portion 21 has an abbreviated hexagonal shape in a cross-sectional view perpendicular to the longitudinal direction (hereinafter, simply referred to as “cross-sectional view”), and each of the surrounding portion 22 is formed in an abbreviated fan shape extending radially outward from the six sides of the central portion 21. The central portion 21 and each of the surrounding portion 22 are fitted together to form a circular cross-section as a whole.

The second metal part 3 covers the central portion 21 and each of the plurality (six in this case) of surrounding portions 22. The central portion 21 and the plurality of surrounding portions 22, as well as circumferentially adjacent ones of the surrounding portions 22, are attached together with the second metal part 3 in between. As a result, the conductivity of the compressed stranded wire conductor 1 is improved as a whole, and its electrical characteristics are enhanced, because the second metal part 3, which has a higher conductivity, is filled between the first metal parts 2 in a striated configuration. For example, even when transmitting high-frequency signals in which skin effects may appear, the electrical characteristics are less likely to deteriorate due to the second metal part 3 which has the high conductivity. In addition, since the first metal part 2 is coated with the second metal part 3, the conductor is less prone to breakage during a compression process that is described below, making it easier to manufacture even when the diameter is reduced.

The compressed stranded wire conductor 1 is composed of seven metal strands 4 coated with a second metal part 3 around the first metal part 2. In other words, the second metal part 3 is a plating layer covering the perimeter of the first metal part 2. In the present embodiment, silver-plated copper alloy wires having the second metal part 3 made of silver coating around the first metal part 2 made of copper alloy, were used as the metal strands 4.

In manufacturing the compressed stranded wire conductor 1, first, seven metal strands 4 are concentrically twisted, next, the twisted strands are heat treated (e.g., temperature 300° C., wire speed 80 m/min), and then the strands are passed through a die for the compression process. The heat treatment before compression is performed to make the metal strands 4 easier to deform and less prone to breakage during the compression process. In particular, in the present embodiment, the heat treatment before compression is essential, because the compression is performed with high strength to the extent that the metal strands 4 are attached to each other with almost no gaps. In the compression process, it is desirable to adjust in such a manner that the tensile strength be in the range of 500 MPa to 650 MPa (500 MPa or more and 650 MPa or less) and the elongation be about 1%, for example. After that, another heat treatment (e.g., temperature of about 600° C. and linear velocity of 70 m/min or less) is performed. This removes the strain applied in the compression process, and accordingly, the decrease in conductivity due to strain is eliminated and the conductivity of the compressed stranded wire conductor 1 is improved. In the above-mentioned method, the compressed stranded wire conductor 1 is obtained.

When a metal strand 4 having only the first metal part 2 without the second metal part 3 is used, an oxide film is formed on the surface of the first metal part 2 during the heat treatment before compression, and the oxide film reduces the electrical conductivity of the compressed stranded wire conductor 1 and deteriorates its appearance. Furthermore, when the metal strand 4 having only the first metal part 2 is used, the surface of metal strand 4 is scratched by rubbing against a die during the compression process, as a result, the wire is prone to breakage at the point of the scratches. In contrast, in the present embodiment, the metal strand 4 is coated with a second metal part 3 around the first metal part 2, so there is no risk of an oxide film being formed during heat treatment, and a good appearance can be maintained. Also, in the compression process, the second metal part 3 serves as a protective layer to protect the surface of the first metal part 2, making it difficult for wire breakage to occur.

In the compressed stranded wire conductor 1 according to the present embodiment, it is desirable that the ratio of the cross-sectional area occupied by the second metal part 3 to the total cross-sectional area in the cross-section perpendicular to the longitudinal direction be 10% or more. This increases the ratio of the second metal part 3 with high conductivity, thereby increasing the conductivity of the entire compressed stranded wire conductor 1 and improving its electrical characteristics.

The inventors of the present invention have examined and found that when forming the compressed stranded wire conductor 1 with a very thin outer diameter of 0.1 mm or less, as in the case of the present embodiment, the ratio of the cross-sectional areas of the first metal part 2 to the second metal part 3 changes before and after the compression process. More specifically, it was found that the ratio of the cross-sectional area occupied by the second metal part 3 to the total cross-sectional area becomes larger (i.e., the ratio of the cross-sectional area occupied by the first metal part 2 to the total cross-sectional area becomes smaller) after the compression process than before the compression process. This is thought to be due to the fact that the first metal part 2, which is relatively hard and subject to more stress concentration, was stretched more than the second metal part 3, which is relatively soft, when it was compressed while being stretched through the die in the compression process.

The following is an example case in which seven metal strands 4 having an outer diameter of 0.045 mm and the second metal part 3, which is the plating layer with a thickness of 1 μm or less, are twisted together to form the compressed stranded wire conductors 1 with an outer diameter of 0.092 mm and 0.089 mm (38 AWG). The ratio of the cross-sectional area of the second metal part 3 to the total cross-sectional area of the compressed stranded wire conductor 1 before compression is approximately 4.4% or less. In contrast, Table 1 shows the measurement results of the cross-sectional area of the compressed stranded wire conductor 1 that was actually produced. In Examples 1 and 2, the outer diameter was 0.092 mm, in Examples 3 and 4, the outer diameter was 0.089 mm, and the wire speed was 50 m/min in Examples 1 and 3 and 20 m/min in Examples 2 and 4.

TABLE 1

| | | | | | | | | | | | | Ratio of | Ratio of |
|---|---|---|---|---|---|---|---|---|---|---|---|---|---|
| | | | | | | | | | | | | First | Second |
| | | | | | | | | | | | | Metal | Metal |
| | Outer | | | | | | | | | | | Part to | Part to |
| | Diameter of | | Cross-Sectional Area (μm²) | | | | | | | | | Total | Total |
| | Compressed | | First Metal Part | | | | | | | | | Cross- | Cross- |
| | Stranded | Wire | Central | | | | | | | | Second | Sectional | Sectional |
| | Conductor | Speed | Portion | Surrounding Portions | | | | | | | Metal | Area | Area |
| Example | (mm) | (m/min) | 1 | 2 | 3 | 4 | 5 | 6 | 7 | Average | Part | (%) | (%) |
| 1 | 0.092 | 50 | 811 | 876 | 890 | 908 | 828 | 831 | 801 | 856 | 848 | 88 | 12 |
| 2 | | 20 | 791 | 891 | 901 | 874 | 813 | 793 | 825 | 850 | 907 | 87 | 13 |
| 3 | 0.089 | 50 | 717 | 763 | 791 | 766 | 772 | 743 | 761 | 766 | 703 | 88 | 12 |
| 4 | | 20 | 697 | 772 | 734 | 728 | 764 | 776 | 742 | 753 | 632 | 89 | 11 |

As shown in Table 1, it can be seen that the ratio of the cross-sectional area occupied by the second metal part 3 to the total cross-sectional area is more than 10% in all cases of Examples 1 through 4. It can also be seen from Table 1 that in the first metal part 2, the cross-sectional area of the central portion 21 is smaller than the average of the cross-sectional areas of the plurality of surrounding portions 22. This is considered to be due to the fact that the stress of compression was concentrated in the central portion 21. It is desirable that the cross-sectional area of the central portion 21 be from 92% to 95% (92% or more and 95% or less) of the average of the cross-sectional areas of the plurality of surrounding portions 22.

When the ratio of the second metal part 3, which is a plating layer, becomes too large, it may lead to a decrease in mechanical strength. Thus, it is desirable that the ratio of the cross-sectional area occupied by the second metal part 3 to the total cross-sectional area in the cross-section perpendicular to the longitudinal direction be 15% or less.

In addition, in the present embodiment, the thickness of the second metal part 3 between the plurality of surrounding portions 22, is at least, greater than the thickness on the outer circumferential surface of the compressed stranded wire conductor 1 (outer circumferential surface of the conductor). This is because there are two layers of the second metal part 3 between the surrounding portions 22, whereas there is only one layer of the second metal part 3 on the outer circumferential surface of the compressed stranded wire conductor 1.

It is desirable that the compressed stranded wire conductor 1 be compressed in such a manner that almost no gaps are created between the metal strands 4. It is desirable that the compressed stranded wire conductor 1 be compressed in such a manner that almost no gaps are created between the metal strands 4. Also, it is desirable that the ratio of an area of a void 5 to an area of a conductor bounding circle, which is circumscribed by the compressed stranded wire conductor 1, in the cross-section perpendicular to the longitudinal direction, be less than 1.5%. This makes the metal strands 4 attached to one another without any gaps (in contact on the surface), which improves electrical characteristics and suppresses unintentional untwisting during terminal processing, thereby improving workability during terminal processing. In addition, since the amount of air present between the metal strands 4 is extremely small, voids are less likely to occur when the compressed stranded wire conductor 1 is soldered to electrodes or the like (this point will be discussed later). Furthermore, since the metal strands 4 are not bonded to one another, each metal strand 4 can move in the longitudinal direction when subjected to bending, twisting, rocking, squeezing, or other actions (called “bending or other actions”), and thus, the strands are highly resistant to bending or other actions.

### (Cable 10)

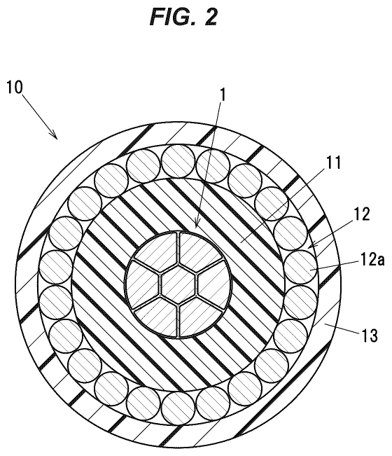

FIG. 2 is a cross-sectional view perpendicular to the longitudinal direction of the cable 10. As shown in FIG. 2, the cable 10 uses the compressed stranded wire conductor 1 of the present embodiment as a conductor, and has at least the compressed stranded wire conductor 1 and a sheath covering around the compressed stranded wire conductor 1. The example in FIG. 2 shows a case in which the cable 10 is a coaxial cable having an insulator 11, a shield layer 12, and a jacket layer 13 sequentially around the compressed stranded wire conductor 1. In this case, the outermost jacket layer 13 corresponds to the sheath.

The insulator 11 is formed to cover the perimeter of the compressed stranded wire conductor 1, which is a center conductor. Here, the case in which the insulator 11 is a single layer is shown, but it is not limited to this, the insulator 11 may be composed of multiple layers. In that case, the insulator 11 may have a foamed layer made of foamed resin covering the perimeter of the compressed stranded wire conductor 1 and a non-foamed skin layer covering the perimeter of the foamed layer. The foamed layer can reduce the dielectric constant of the insulator 11 and improve the electrical characteristics, especially when transmitting high-frequency signals. Since the foamed layer has bubbles, the insulation between the compressed stranded wire conductor 1 and the shield layer 12 can be secured by covering the surrounding area with a non-foamed skin layer.

The shield layer 12 is composed of a horizontally wound shield with a plurality of metal strands 12a spirally wound around the insulator 11. The metal strands 12a are made of copper or copper alloy. The metal strand 12a may be plated on its surface with a plating made of silver, tin, or the like. It is desirable to use a metal strand 12a made of silver-plated copper alloy to increase the conductivity and mechanical strength of the shield layer 12.

The jacket layer 13 is provided to cover the perimeter of the shield layer 12. It is desirable that the jacket layer 13 be configured, for example, by wrapping a resin tape around. More specifically, for example, the jacket layer 13 may consist of two layers, with the first layer made of a non-adhesive resin tape spirally wound in such a manner that a portion of the tape overlaps in the width direction, and the second layer made of an adhesive resin tape having a hot melt type adhesive layer on one side of the resin layer, and spirally wound in such a manner that a portion of the tape overlaps in the width direction with the adhesive layer of the resin tape inside. The adhesive layer is then heated to be melt and bonded to the first layer of non-adhesive resin tape to form the jacket layer 13. As the resin comprising the resin tape, PET (polyethylene terephthalate), PI (polyimide), PEEK (polyetheretherketone), PEI (polyetherimide), or the like, can be used.

Although the case where the cable 10 is a coaxial cable is described here, the specific structure of the cable 10 is not limited to what is shown in the figures. For example, it may be an insulated wire having an insulator 11 around the compressed stranded wire conductor 1.

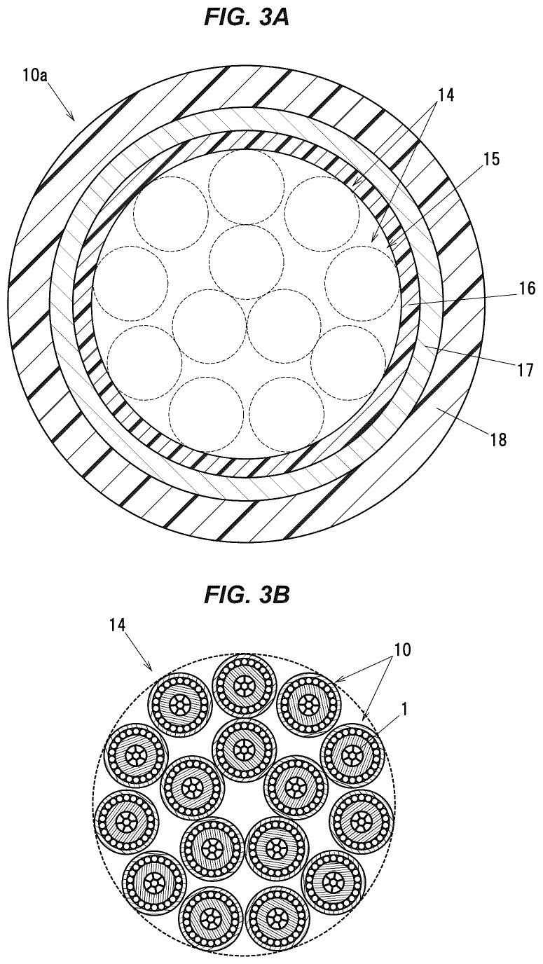

As shown in FIGS. 3A and 3B, the cable 10 may be a multi-core cable 10a using the compressed stranded wire conductor 1 as a core conductor. In the example shown in FIG. 3, the multi-core cable 10a is composed of a cable core 15, which is configured by twisting together 12 child strands 14, each of which comprises 16 cables 10 (coaxial cable) shown in FIG. 2, a binding tape 16 wrapped around the cable core 15, a bulk (collective) shield layer 17 covering the perimeter of the binding tape 16, and a sheath 18 covering the perimeter of the bulk shield layer 17.

The cable core 15 is composed of three child strands 14 twisted together and nine child strands 14 twisted around the three child strands 14. Each layer of the cable core 15 is twisted in the same direction. The binding tape 16 is spirally wrapped around the cable core 15 in such a manner that a portion of its width direction overlaps. The bulk shield layer 17 is a braided shield made of multiple strands braided together. It is desirable that the sheath 18 be formed by tube extrusion in such a manner that the resin comprising the sheath 18 does not penetrate between the strands of the bulk shield layer 17.

### (Connection Structure 100)

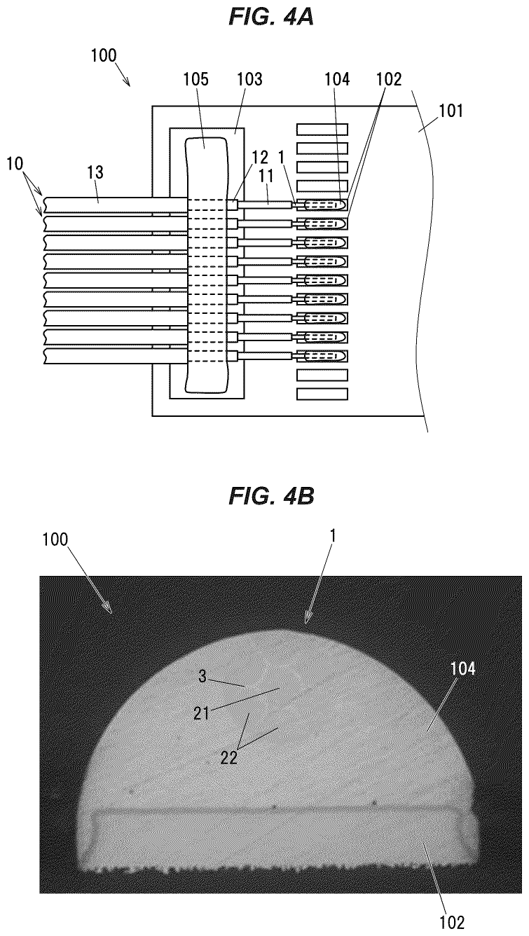

FIG. 4A is a plan view of a connection structure 100 according to an embodiment of the present invention. FIG. 4B is a photograph showing a cross-section at the connection portion between the compressed stranded wire conductor 1 and the electrode 102.

As shown in FIG. 4A, the connection structure 100 is composed of the compressed stranded wire conductor 1 and the electrode 102 formed on a substrate 101, connected by solder 104. The illustration shows a case in which a plurality of cables 10 (coaxial cables) of FIG. 2 are connected to the substrate 101. A plurality of electrodes 102 (signal electrodes) corresponding to the compressed stranded wire conductors 1 of the cables 10 and a ground electrode 103 common to the cables 10 are formed on the substrate 101. The plurality of electrodes 102 are aligned perpendicularly to the extension direction of the cables 10, and the ground electrode 103 is formed on the extension side of the cables 10 with respect to the plurality of electrodes 102.

At their terminal ends, each of the cables 10 has a shield layer 12 exposed from the end of the jacket layer 13, an insulator 11 exposed from the end of the shield layer 12, and a compressed stranded wire conductor 1 exposed from the end of the insulator 11. The shield layers 12 of the cables 10 are collectively connected to the common ground electrode 103 by solder 105, and the compressed stranded wire conductors 1 of the cables 10 are connected to the corresponding electrodes 102 respectively by the solder 104.

As shown in FIG. 4B, the compressed stranded wire conductor 1 is not easily untangled during terminal processing and can maintain its cross-sectional shape. Namely, the compressed stranded wire conductor 1 maintains the state where the central portion 21 and the plurality of surrounding portions 22 as well as the adjacent surrounding portions 22 are in close contact with sandwiching the second metal part 3. Therefore, the solder 104 does not penetrate into the inside of the compressed stranded wire conductor 1, and the soldering can be performed evenly in such a manner that the solder 104 surrounds the outer circumference of the compressed stranded wire conductor 1. Therefore, voids (bubbles) in the solder 104 are less likely to occur and the compressed stranded wire conductor 1 is less likely to come loose from the solder 104, resulting in a highly reliable connection. In addition, since the cross-sectional shape of the compressed stranded wire conductor 1 is less likely to be disturbed, the surface of the solder 104 can be easily made into a clean arc shape.

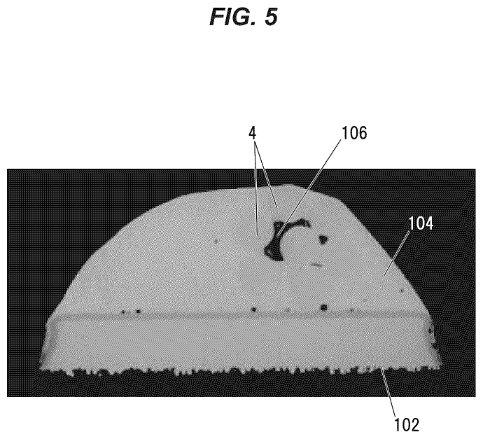

On the other hand, in the case of a stranded conductor simply configured by twisting seven metal strands 4 concentrically, the solder 104 can easily get into between the metal strands 4 and disrupt the arrangement of the metal strands 4, easily generating a void 106 as shown in FIG. 5, for example. As a result, the fixation of the metal strands 4 may vary, and when a pulling force or the like is applied to the conductor for some reason, the stress may be concentrated only on the metal strands 4, resulting in disconnection, which lowers the reliability of the connection. In addition, the surface of the solder 104 is also disturbed by the disruption of the metal strands 4, making it difficult for the surface of the solder 104 to form a clean arc shape and degrading its appearance.

In addition, in the connection structure 100 according to the present embodiment, the area required for soldering can be reduced (to the same level as when a single wire conductor is used) because the strands of the compressed stranded wire conductors 1 are not easily untangled. As a result, a plurality of the compressed stranded wire conductors 1 can be connected in parallel at a narrow pitch, contributing to higher wiring density and miniaturization of equipment using the substrate 101 or the like.

### Functions and Effects of the Embodiment

As described above, the compressed stranded wire conductor 1 according to the present embodiment comprises: an outer diameter of 0.1 mm or less; the central portion 21; a plurality of the surrounding portions 22 spirally twisted around the central portion 21; the first metal part 2 wherein the central portion 21 and the plurality of surrounding portions 22 being fitted together to form a circular cross-section as a whole; and the second metal part 3 made of a metal having a higher conductivity than the first metal part 2 and covering each of the central portion 21 and the plurality of surrounding portions 22, wherein the central portion 21, the plurality of surrounding portions 22, and adjacent ones of the surrounding portions 22 are attached together with the second metal part 3 in between.

According to this configuration, the second metal part 3 which has a high conductivity is included in a striated state in the cross-sectional view, which can increase conductivity of the entire compressed stranded wire conductor 1 and improve electrical characteristics. In addition, by using metal strand 4 in which the first metal part 2 is coated with the second metal part 3, the second metal part 3 acts as a protective layer. Therefore, the compressed stranded wire conductor 1 can be realized with a thin diameter and less susceptibility to wire breakage during manufacturing. It is conceivable to manufacture a wire with low tension to prevent wire breakage, but in this case, the adjustment of tension increases the difficulty of manufacturing, and also increases the difficulty to obtain the desired electrical characteristics. According to the present embodiment, even if the conductor is manufactured with a certain amount of high tension, wire breakage is less likely to occur, which facilitates manufacturing and realizing the compressed stranded wire conductor 1 with high productivity.

### Summary of the Embodiment and Modifications

Next, technical ideas understood from the above embodiment will be described with reference to the reference numerals and the like used in the embodiment. However, each reference numeral in the following description does not limit the constituent elements in the scope of claims to the members and the like specifically shown in the embodiments.

[1] A compressed stranded wire conductor (1), comprising:
an outer diameter of 0.1 mm or less;
a central portion (21);
a plurality of surrounding portions (22) spirally twisted around the central portion (21);
a first metal part (2) in which the central portion (21) and the plurality of surrounding portions (22) being fitted together to form a circular cross-section as a whole; and
a second metal part (3) made of a metal having a higher conductivity than the first metal part (2), covering each of the central portion (21) and the plurality of surrounding portions (22),
wherein the central portion (21) and the plurality of surrounding portions (22), and adjacent ones of the surrounding portions (22) are attached together with the second metal part (3) in between.

[2] The compressed stranded wire conductor (1) according to [1], wherein a ratio of the cross-sectional area occupied by the second metal part (3) to a total cross-sectional area in a cross-section perpendicular to a longitudinal direction is 10% or more.

[3] The compressed stranded wire conductor (1) according to [1], wherein a ratio of the cross-sectional area occupied by the second metal part (3) to a total cross-sectional area in a cross-section perpendicular to a longitudinal direction is 15% or less.

[4] The compressed stranded wire conductor (1) according to [1], wherein a cross-sectional area of the central portion (21) is smaller than an average cross-sectional area of the plurality of the surrounding portions (22) in a cross-section perpendicular to a longitudinal direction.

[5] The compressed stranded wire conductor (1) according to [1], wherein a thickness of the second metal portion (3) between the plurality of surrounding portions (22) is at least greater than that on an outer circumferential surface of the conductor.

[6] The compressed stranded wire conductor (1) according to [1], wherein the first metal part (2) is made of copper or a copper alloy and the second metal part (3) is made of silver.

[7] The compressed stranded wire conductor (1) according to [1], wherein the first metal part (2) is made of a copper alloy and the second metal part (3) is made of copper.

[8] The compressed stranded wire conductor (1) according to [1], wherein the outer diameter is 0.061 mm or less.

[9] The compressed stranded wire conductor (1) according to [1], wherein a ratio of an area of a void (5) to an area of a conductor circumscribed circle in a cross-section perpendicular to a longitudinal direction is 1.5% or less.

[10] A cable (10, 10a), comprising at least the compressed stranded wire conductor (1) according to any of [1] to [9] and a sheath (jacket layer 13, sheath 18) covering around the compressed stranded wire conductor (1).

[11] A connection structure (100) in which a conductor and an electrode (102) formed on a substrate (101) are connected by solder (104),
wherein the conductor has an outer diameter of 0.1 mm or less, a central portion (21), and a plurality of surrounding portions (22) spirally twisted around the central portion (21), and comprises:
a first metal part (2) wherein the central portion (21) and the plurality of the surrounding portions (22) fitted together to form a circular cross-section as a whole, and a second metal part (3) made of a metal having a higher conductivity than a first metal part (2), covering each of the central portion (21) and the plurality of surrounding portions (22),
wherein the central portion (21), the plurality of surrounding portions (22), and adjacent ones of the surrounding portions (22) are attached together with the second metal part (3) in between, and
wherein the solder (104) does not enter into the compressed stranded wire conductor (1).

That is all for the description of the embodiment of the present invention, but the above embodiment does not limit the invention according to the scope of claims. Also, it should be noted that not all of the combinations of features described in the embodiment are essential to the means for solving the problems of the invention. In addition, the invention can be appropriately implemented with various modifications without departing from the scope and spirit of the invention.

1. A compressed stranded wire conductor, comprising:
an outer diameter of 0.1 mm or less;
a central portion;
a plurality of surrounding portions spirally twisted around the central portion;
a first metal part in which the central portion and the plurality of surrounding portions are fitted together to form a circular cross-section as a whole; and
a second metal part made of a metal having higher conductivity than the first metal part and covering each of the central portion and the plurality of surrounding portions,
wherein the central portion, the plurality of the surrounding portions, and adjacent ones of the surrounding portions, are attached together with the second metal part in between.

2. The compressed stranded wire conductor according to claim 1, wherein a ratio of a cross-sectional area occupied by the second metal part to a total cross-sectional area is 10% or more, in a cross-section perpendicular to a longitudinal direction.

3. The compressed stranded wire conductor according to claim 1, wherein a ratio of a cross-sectional area occupied by the second metal part to a total cross-sectional area is 15% or less, in a cross-section perpendicular to a longitudinal direction.

4. The compressed stranded wire conductor according to claim 1, wherein a cross-sectional area of the central part is smaller than an average of cross-sectional areas of the plurality of surrounding portions, in a cross-section perpendicular to a longitudinal direction.

5. The compressed stranded wire conductor according to claim 1, wherein a thickness of the second metal part between the plurality of surrounding portions, is at least, greater than a thickness on an outer circumferential surface of the conductor.

6. The compressed stranded wire conductor according to claim 1, wherein the first metal part is made of copper or copper alloy and the second metal part is made of silver.

7. The compressed stranded wire conductor according to claim 1, wherein the first metal part is made of copper alloy and the second metal part is made of copper.

8. The compressed stranded wire conductor according to claim 1, wherein the outer diameter is 0.061 mm or less.

9. The compressed stranded wire conductor according to claim 1, wherein a ratio of an area of a void to an area of a conductor circumscribed circle is 1.5% or less, in a cross-section perpendicular to a longitudinal direction.

10. A cable having at least the compressed stranded wire conductor according to claim 1, and a sheath covering around the compressed stranded wire conductor.

11. A connection structure in which a conductor and an electrode formed on a substrate are connected by solder,
wherein the conductor comprises:
an outer diameter of 0.1 mm or less;
a central portion;
a plurality of surrounding portions spirally twisted around the central portion;
a first metal part in which the central portion and plurality of surrounding portions are fitted together to form a circular cross-section as a whole; and
a second metal part made of a metal having a higher conductivity than a first metal part, covering each of the central portion and the plurality of surrounding portions,
wherein the central portion, the plurality of surrounding portions, and adjacent ones of the surrounding portions are attached together with the second metal part in between, and
wherein the solder does not enter into the compressed stranded wire conductor.
